(19) United States
(12) Patent Application Publication
(10) Pub. No.: US 2018/0264883 A1
(43) Pub. Date: Sep. 20, 2018

(54) METHOD OF PRODUCING MODIFIED POLYMER, MODIFIED POLYMER, RUBBER COMPOSITION AND PNEUMATIC TIRE

(71) Applicant: THE YOKOHAMA RUBBER CO., LTD., MINATO-KU, TOKYO (JP)

(72) Inventors: Ryota TAKAHASHI, HIRATSUKA-CITY, KANAGAWA (JP); Di ZHANG, HIRATSUKA-CITY, KANAGAWA (JP); Takahiro OKAMATSU, HIRATSUKA-CITY, KANAGAWA (JP)

(21) Appl. No.: 15/744,965

(22) PCT Filed: Aug. 3, 2016
(86) PCT No.: PCT/JP2016/072815

§ 371 Date: Jan. 15, 2018

(30) Foreign Application Priority Data
Aug. 21, 2015 (JP) 2015-164094

(51) Int. Cl. B60C 1/00; C08C 19/22; C08L 9/06; C08K 3/36; C08K 5/32

(52) U.S. Cl. CPC B60C 1/0016; C08C 19/22; C08K 5/32; C08K 3/36; C08L 9/06

(57) ABSTRACT

A method of producing a modified polymer that is capable of reducing heat build-up of a tire, and a modified polymer obtained by the method, a rubber composition including the modified polymer, and a pneumatic tire using the rubber composition, are provided. The method of producing the modified polymer includes modifying a conjugated diene polymer (A) with a nitrone compound (B) having a carboxy group, wherein the nitrone compound (B) is in particulate form, having an average major axis length of not greater than 50 μm.

### TECHNICAL FIELD

The present invention relates to a method of producing a modified polymer, a modified polymer, a rubber composition and a pneumatic tire.

### BACKGROUND ART

Modified polymers that are modified by a compound containing a nitrone group (nitrone compound) have been known conventionally as polymers contained in rubber compositions for use in tires and the like.

For example, Patent Document 1 describes “a modified polymer obtained by reacting a modifier having a nitrone group and a carboxy group with a conjugated diene polymer not containing a tetrasubstituted olefin and/or a trisubstituted olefin (claim 1)” and also describes that a tire containing the modified polymer have low heat build-up ([0005]).

### CITATION LIST

### Patent Literature

Patent Document 1: JP 5716850 B

### SUMMARY OF INVENTION

### Technical Problem

Recently, improved fuel economy performance of vehicles while traveling has been sort due to environmental concerns. Accordingly, demands exist for further reduced heat build-up performance.

Under such circumstances, the present inventors have prepared a rubber composition using the modified polymer described in Patent Document 1, and discovered that there is a room for further improvement in reduction of heat build-up, depending on the type of the nitrone compound as a modifier or the method of preparation.

Thus, in the present invention, a method of producing a modified polymer that is capable of reducing heat build-up of a tire, and a modified polymer obtained by the method, a rubber composition including the modified polymer, and a pneumatic tire using the rubber composition, are provided.

### Solution to Problem

The present inventors conducted the diligent research on the above problems and discovered the use of a dispersed nitrone compound having a carboxy group in a particulate form of a certain size can produce a modified polymer capable of reducing heat build-up of a tire sufficiently. Thus, the present inventors completed the invention.

Specifically, the inventor discovered that the problems described above can be solved by the following features.

1. A method of producing a modified polymer including:

modifying a conjugated diene polymer (A) with a nitrone compound (B) having a carboxy group,

wherein the nitrone compound (B) is in particulate form, having an average major axis length of not greater than 50 μm.

2. The method according to 1, wherein the nitrone compound (B) is represented by Formula (1).

3. The method according to 1 or 2, wherein the nitrone compound (B) is represented by Formula (2).

4. The method according to any one of 1 to 3, wherein the nitrone compound (B) is a compound selected from the group consisting of N-phenyl-α-(4-carboxyphenyl)nitrone, N-phenyl-α-(3-carboxyphenyl)nitrone, N-phenyl-α-(2-carboxyphenyl)nitrone, N-(4-carboxyphenyl)-α-phenylnitrone, N-(3-carboxyphenyl)-α-phenylnitrone, and N-(2-carboxyphenyl)-α-phenylnitrone.

5. The method according to any one of 1 to 4, wherein an amount of the nitrone compound (B) reacted with the conjugated diene polymer (A) is from 0.1 to 10 parts by mass per 100 parts by mass of the conjugated diene polymer (A).

6. A modified polymer obtained by the method described in any one of 1 to 5.

7. A rubber composition including the modified polymer described in 6.

8. A pneumatic tire using the rubber composition described in 7.

### Advantageous Effects of Invention

As described below, according to the embodiments of the present invention, a method of producing a modified polymer that is capable of reducing heat build-up of a tire, and a modified polymer obtained by the method, a rubber composition including the modified polymer, and a pneumatic tire using the rubber composition, are provided.

### BRIEF DESCRIPTION OF DRAWING

FIG. 1 is a partial cross-sectional schematic view of a tire that represents a pneumatic tire according to an embodiment of the present invention.

### DESCRIPTION OF EMBODIMENTS

Various embodiments of the present invention regarding to a method of producing a modified polymer, and a modified polymer obtained by the method, a rubber composition including the modified polymer, and a pneumatic tire using the rubber composition, are described below.

Note that in the present specification, numerical ranges indicated using “(from) . . . to . . . ” include the former number as the lower limit value and the later number as the upper limit value.

### Method for Producing Modified Polymer

A method of producing a modified polymer according to an embodiment of the present invention (also abbreviated as “method of the present invention” hereinafter) is a method of producing a modified polymer, the method including

modifying a conjugated diene polymer (A) with a nitrone compound (B) having a carboxy group.

In the method of the present invention, the nitrone compound (B) above used is in particulate form, having an average major axis length of not greater than 50 μm.

The method of producing the modified polymer according to an embodiment of the present invention, using the nitrone compound (B) in particulate form, having an average major axis length of not greater than 50 μm, may provide a modified polymer which can reduce heat build-up of a tire sufficiently. Although the reason is not clear, it is assumed to be as follows.

First, the modifier described in Patent Document 1 (i.e. the nitrone compound having a carboxy group and a nitrone group) has a high melting point. Therefore, it is assumed that, the nitrone compound being present in the reaction system as a particle, the reaction with the conjugated diene polymer takes place at the surface of the nitrone compound particles.

On the other hand, in the method of the present invention, the nitrone compound having a carboxy group is in particulate form, having an average major axis length of not greater than 50 μm, resulting in an increase in reactive sites (surface area of the particle) of the nitrone compound present in the reaction system as a particle. Thus, the reaction of the nitrone compound with the conjugated diene polymer may proceed readily, and this results in the increase in degree of modification, and consequently in sufficient reduction in heat build-up of a tire.

Details of the conjugated diene polymer (A), the nitrone compound (B) having a carboxy group, and the reaction conditions thereof and the like are described below.

### Conjugated Diene Polymer (A)

The conjugated diene polymer (A) used in the production of the modified polymer is not particularly limited. Specific examples thereof include a natural rubber (NR), isoprene rubber (IR), butadiene rubber (BR), aromatic vinyl-conjugated diene copolymer rubber (e.g. SBR), acrylonitrile-butadiene copolymer rubber (NBR), butyl rubber (IIR), halogenated butyl rubber (Br-IIR, Cl-IIR), and chloroprene rubber (CR).

Among these, a butadiene rubber (BR) and styrene-butadiene rubber (SBR) are preferable, from the viewpoint of further reduction in heat build-up of a tire.

The weight average molecular weight (Mw) of the conjugated diene polymer (A) described above is not particularly limited, but preferably Mw is from 100000 to 2000000, from the perspective of handling. In the present disclosure, the weight average molecular weight (Mw) is measured by gel permeation chromatography (GPC) using tetrahydrofuran as a solvent, and calibrated using polystyrene standard.

### Nitrone Compound (B)

The nitrone compound (B) used in the production of the modified polymer is a nitrone compound having at least one carboxy group (—COOH) and in particulate form, having an average major axis length of not greater than 50 μm.

Note that “nitrone” is a generic term for compounds in which an oxygen atom is bonded to a nitrogen atom of a Schiff base.

Also, the average major axis length refers to an average value obtained from measurement of the maximum linear distance in the planer direction of randomly selected 100 particles, using a digital microscope (KH-7700, available from Hirox Co., Ltd.) at a magnification of 350.

In the method of the present invention, the nitrone compound (B) is preferably in particulate form, having an average major axis length of from 1 to 50 μm and more preferably in particulate form, having an average major axis length of from 5 to 20 μm, from the viewpoint of the effect of the obtained modified polymer on improving the tensile properties of the rubber composition and on reducing heat build-up of the tire.

The nitrone compound (B) described above is preferably a compound represented by Formula (1) below.

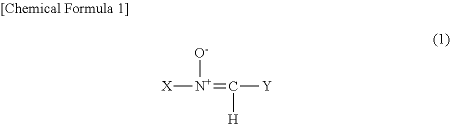

In Formula (1), X and Y each independently represent an aliphatic hydrocarbon group, an aromatic hydrocarbon group, or an aromatic heterocyclic group; and at least one of X and Y includes a carboxy group as a substituent.

Examples of the aliphatic hydrocarbon group represented by X or Y include alkyl groups, cycloalkyl groups, and alkenyl groups. Examples of the alkyl groups include methyl groups, ethyl groups, n-propyl groups, isopropyl groups, n-butyl groups, isobutyl groups, sec-butyl groups, tert-butyl groups, n-pentyl groups, isopentyl groups, neopentyl groups, tert-pentyl groups, 1-methylbutyl groups, 2-methylbutyl groups, 1,2-dimethylpropyl groups, n-hexyl groups, n-heptyl groups, and n-octyl groups. Among these, alkyl groups having from 1 to 18 carbons are preferable, and alkyl groups having from 1 to 6 carbons are more preferable. Examples of the cycloalkyl groups include cyclopropyl groups, cyclobutyl groups, cyclopentyl groups, and cyclohexyl groups. Among these, cycloalkyl groups having from 3 to 10 carbons are preferable, and cycloalkyl groups having from 3 to 6 carbons are more preferable. Examples of the alkenyl groups include vinyl groups, 1-propenyl groups, allyl groups, isopropenyl groups, 1-butenyl groups, and 2-butenyl groups. Among these, alkenyl groups having from 2 to 18 carbons are preferable, and alkenyl groups having from 2 to 6 carbons are more preferable.

Examples of the aromatic hydrocarbon group represented by X or Y include aryl groups, and aralkyl groups.

Examples of the aryl group include a phenyl group, a naphthyl group, an anthryl group, a phenanthryl group, and a biphenyl group. Among these, aryl groups having from 6 to 14 carbons are preferable, aryl groups having from 6 to 10 carbons are more preferable, and a phenyl group and a naphthyl group are even more preferable.

Examples of the aralkyl groups include benzyl groups, phenethyl groups, and phenylpropyl groups. Among these, aralkyl groups having from 7 to 13 carbons are preferable, aralkyl groups having from 7 to 11 carbons are more preferable, and a benzyl group is even more preferable.

Examples of the aromatic heterocycle group represented by X or Y include a pyrrolyl group, a furyl group, a thienyl group, a pyrazolyl group, an imidazolyl group (an imidazole group), an oxazolyl group, an isoxazolyl group, a thiazolyl group, an isothiazolyl group, a pyridyl group (a pyridine group), a furan group, a thiophene group, a pyridazinyl group, a pyrimidinyl group, and a pyrazinyl group. Among these, a pyridyl group is preferable.

At least one of X and Y has a carboxy group as a substituent.

Examples of the substituents which can be included in addition to the carboxy group include alkyl groups having from 1 to 4 carbons, hydroxy groups, amino groups, nitro groups, sulfonyl groups, alkoxy groups, and halogen atoms.

Note that examples of the aromatic hydrocarbon group having such a substituent include aryl groups having a substituent, such as a tolyl group and xylyl group; and aralkyl groups having a substituent, such as a methylbenzyl group, ethylbenzyl group, and methylphenethyl group.

The compound represented by Formula (1) above is preferably a compound represented by Formula (2) below.

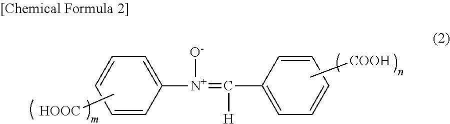

In Formula (2), m and n each independently represent integers of 0 to 5, and the sum of m and n is 1 or greater.

The integer represented by m is preferably an integer from 0 to 2, and more preferably an integer 0 or 1, because solubility to a solvent during nitrone compound synthesis is better, thereby making the synthesis easier.

The integer represented by n is preferably an integer from 0 to 2, and more preferably an integer of 0 or 1, because solubility to a solvent during nitrone compound synthesis is better, thereby making the synthesis easier.

Furthermore, the sum of m and n, (m+n), is preferably from 1 to 4, and more preferably 1 or 2.

The carboxynitrone represented by Formula (2) is not particularly limited but is preferably a compound selected from the group consisting of N-phenyl-α-(4-carboxyphenyl)nitrone represented by Formula (2-1) below, N-phenyl-α-(3-carboxyphenyl)nitrone represented by Formula (2-2) below, N-phenyl-α-(-2-carboxyphenyl)nitrone represented by Formula (2-3) below, N-(-4-carboxyphenyl)-α-phenylnitrone represented by Formula (2-4) below, N-(-3-carboxyphenyl)-α-phenylnitrone represented by Formula (2-5) below, and N-(2-carboxyphenyl)-α-phenylnitrone represented by Formula (2-6) below.

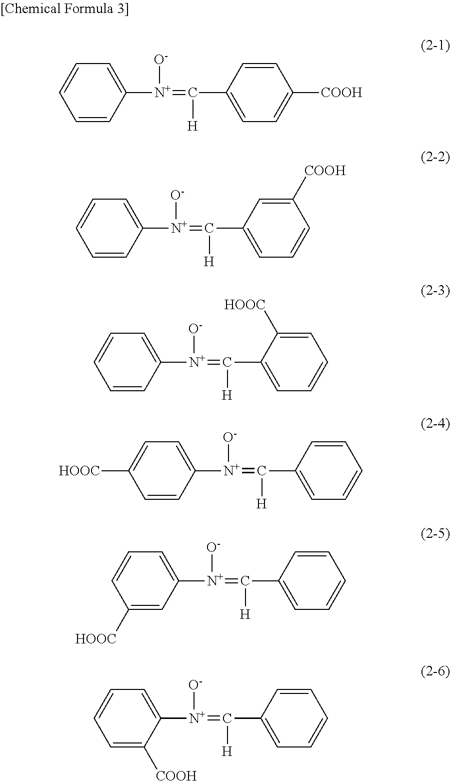

The method of synthesizing the nitrone compound (B) is not particularly limited, and conventionally known methods can be used. For example, nitrones having a nitrone group are obtained by stirring a compound having a hydroxyamino group (—NHOH) and a compound having an aldehyde group (—CHO) at a molar ratio of hydroxyamino group to aldehyde group (—NHOH/—CHO) of from 1.0 to 1.5 in the presence of an organic solvent (for example methanol, ethanol, and tetrahydrofuran) at room temperature for from 1 to 24 hours to allow the both groups to react.

Also, the method of preparing the nitrone compound (B) described above to a particulate form having an average major axis length of not greater than 50 μm is not particularly limited. Examples of such methods include pulverizing the nitrone compound obtained as above mechanically using a pestle and mortar, ball mill, hammer mill, CF mill, atomizer mill, pulverizer, and the like; pulverizing using a wind power such as a jet mill; micronizing by recrystallization treatment; and the combination thereof.

### Reaction Conditions

In the method of the present invention, the conditions for the reaction between the conjugated diene polymer (A) and the nitrone compound (B) are not particularly limited. Examples of the method include blending these compounds at a temperature of from 100° C. to 200° C. for from 1 to 30 minutes.

At this time, a cycloaddition reaction occurs between the double bonds originating from conjugated diene in the conjugated diene polymer (A) and the nitrone groups of the nitrone compound (B), forming a five-membered ring as illustrated in Formula (3) or Formula (4) below. Note that Formula (3) below represents a reaction between a 1,4 bond and a nitrone compound, and Formula (4) below represents a reaction between a 1,2-vinyl bond and a nitrone compound. Furthermore, Formula (3) and (4) represent reactions in the case where the conjugated diene is butadiene (1,3-butadiene); however, even when the conjugated diene is other than butadiene, the five-membered ring is obtained by a similar reaction.

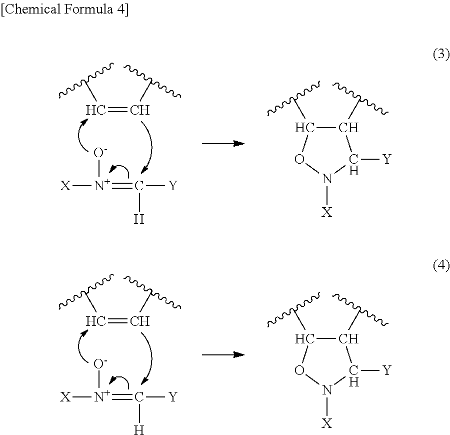

The amount of the nitrone compound (B) reacted with the conjugated diene polymer (A) is not particularly limited and is preferably from 0.1 to 10 parts by mass, and more preferably from 0.3 to 5 parts by mass, per 100 parts by mass of the conjugated diene polymer (A).

### Modified Polymer

The modified polymer according to an embodiment of the present invention is a modified polymer obtained by the production method of the present invention described above.

The degree of modification of the modified polymer according to an embodiment is not particularly limited but is preferably not less than 0.10 mol %, and more preferably not less than 0.20 mol % from the viewpoint of greater reduction in heat build-up facilitated by such modification. Although the upper limit value of the degree of modification is not particularly limited, the upper limit value is preferably not greater than 2.0 mol %.

Here, “degree of modification” refers to a proportion (mol %) of double bonds modified with the nitrone compound (B) relative to all the double bonds of conjugated diene contained in the conjugated diene polymer (A), and more specifically refers to a proportion (mol %) of the structure of Formula (3) above or Formula (4) above that is formed due to the modification with the nitrone compound (B). The degree of modification, for example, can be determined by NMR measurement of the conjugated diene polymer (A) and the modified polymer (that is, the polymers before and after modification).

The modified polymer according to an embodiment of the present invention forms a five-membered ring structure as described above using Formula (3) and (4).

Thus, the modified polymer according to an embodiment of the present invention preferably has a five-membered ring structure represented by Formula (5) below, derived from the nitrone compound (A) above, and/or a five-membered ring structure represented by Formula (6) below, derived from the nitrone compound (A), and more preferably has a five-membered ring structure represented by Formula (5-1) below and/or a five-membered ring structure represented by Formula (6-1) below. Note that, in Formula (5) and (6) below and Formula (5-1) and (6-1) below, X and Y are synonymous with X and Y in Formula (1) described above.

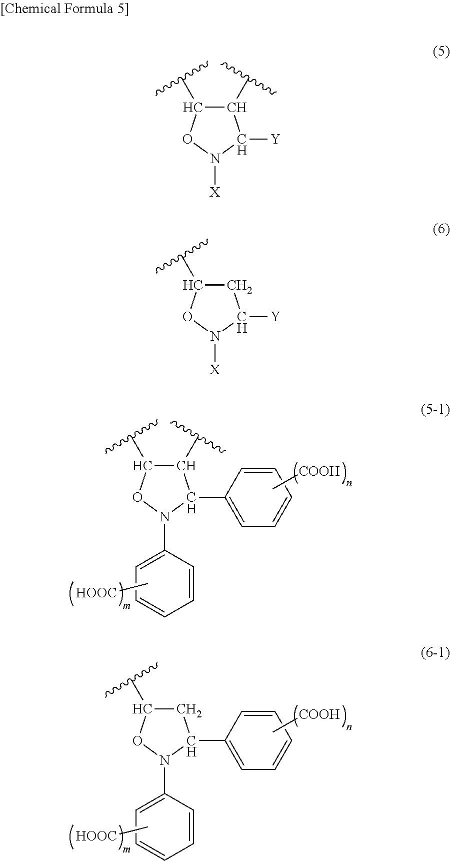

### Rubber Composition

The rubber composition according to an embodiment of the present invention (may referred to as “rubber composition of the present invention” hereinafter) is a rubber composition including the modified polymer according to an embodiment of the present invention.

The modified polymer according to an embodiment of the present invention is described above.

When the composition of the present invention includes a diene rubber in addition to the modified polymer, the content of the modified polymer according to an embodiment of the present invention relative to the total of the additional diene rubber and the modified polymer is not particularly limited, but preferably from 10 to 100 mass % and more preferably from 10 to 60 mass %.

The composition according to an embodiment of the present invention may further contain an additional component as necessary within the scope that does not inhibit the effect or purpose thereof.

Examples of such a component include various additives that are typically used in rubber compositions, such as the diene rubber other than the modified polymer according to an embodiment of the present invention, silica, carbon black, silane coupling agents (e.g., Si69, available from Evonic Degussa Corporation; and Si 363, available from Evonic Degussa Corporation), zinc oxide (flower of zinc), stearic acid, anti-aging agent, processing aids, oils, liquid polymers, terpene resins, thermosetting resins, vulcanizing agent (e.g. sulfur), and vulcanization accelerators.

### Diene Rubber

The composition of the present invention preferably includes a diene rubber in addition to the modified polymer described above.

The diene rubber is not particularly limited, but specific examples of the other diene rubber include natural rubber (NR), isoprene rubber (IR), butadiene rubber (BR), aromatic vinyl-conjugated diene copolymer rubber, acrylonitrile-butadiene copolymer rubber (NBR), butyl rubber (IIR), halogenated butyl rubber (Br-IIR, Cl-IIR), and chloroprene rubber (CR). A single type of other diene rubber may be used alone, or two or more types may be used in combination.

In the present invention, a natural rubber (NR), butadiene rubber (BR), or aromatic vinyl-conjugated diene copolymer rubber is preferably used as the diene rubber described above, and the combination of two or more thereof is more preferable.

Examples of the aromatic vinyl-conjugated diene copolymer rubber described above include styrene-butadiene copolymer rubber (SBR), and styrene-isoprene copolymer rubber. Of these, styrene-butadiene copolymer rubber (SBR) is preferable from the perspective of wear resistance of the resulting tire.

### Silica

The composition according to an embodiment of the present invention preferably includes silica.

The silica is not particularly limited, and any conventionally known silica that is blended in rubber compositions for use in tires or the like can be used.

Specific examples of silica include wet silica, dry silica, fumed silica, and diatomaceous earth. One type of the silica may be used alone, or two or more types of the silicas may be used in combination.

In one embodiment, the silica preferably contains a wet silica from the perspective of the reinforcement of the rubber.

The content of the silica described above is not particularly limited, but is preferably from 20 to 130 parts by mass, and more preferably from 25 to 95 parts by mass, per 100 parts by mass of the total of the modified polymer and the diene rubber described above.

### Carbon Black

The composition according to an embodiment of the present invention preferably includes carbon black.

The carbon black is not particularly limited and, for example, carbon blacks of various grades, such as SAF-HS, SAF, ISAF-HS, ISAF, ISAF-LS, IISAF-HS, HAF-HS, HAF, HAF-LS, and FEF, can be used.

The content of the carbon black is not particularly limited, but is preferably from 1 to 100 parts by mass, and more preferably from 3 to 60 parts by mass, per 100 parts by mass of total of the modified polymer and the diene rubber described above.

### Method for Producing Rubber Composition

The method of producing the composition according to an embodiment of the present invention is not particularly limited. Specific examples thereof include a method whereby each of the above-mentioned components is kneaded using a publicly known method and device (e.g. Banbury mixer, kneader, and roll). When the composition according to an embodiment of the present invention contains sulfur or a vulcanization accelerator, the components other than the sulfur and the vulcanization accelerator are preferably blended first (for example, blended at a temperature of from 60° C. to 160° C.), then cooled, before blending the sulfur and the vulcanization accelerator.

In addition, the composition according to an embodiment of the present invention can be vulcanized or crosslinked under conventionally known vulcanizing or crosslinking conditions.

### Pneumatic Tire

The pneumatic tire according to an embodiment of the present invention is a pneumatic tire that includes the composition according to an embodiment of the present invention. Moreover, the pneumatic tire according to an embodiment of the present invention is preferably a pneumatic tire that includes the rubber composition according to an embodiment of the present invention in the tire tread.

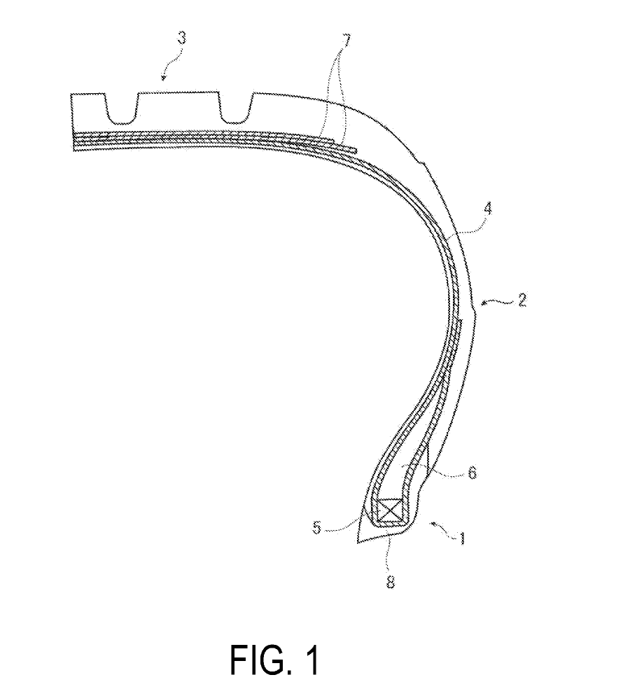

FIG. 1 is a partial cross-sectional schematic view of a tire that represents a pneumatic tire according to an embodiment of the present invention, but the present invention is not limited to the embodiment illustrated in FIG. 1.

In FIG. 1, reference sign 1 denotes a bead portion, reference sign 2 denotes a sidewall portion, and reference sign 3 denotes a tire tread portion.

In addition, a carcass layer 4, in which a fiber cord is embedded, is mounted between a left-right pair of bead portions 1, and ends of the carcass layer 4 are wound by being folded around bead cores 5 and a bead filler 6 from an inner side to an outer side of the tire.

In the tire tread portion 3, a belt layer 7 is provided along the entire periphery of the tire on the outer side of the carcass layer 4.

Additionally, rim cushions 8 are provided in portions of the bead portions 1 that are in contact with a rim.

The pneumatic tire according to an embodiment of the present invention can be produced, for example, in accordance with a conventionally known method. In addition to ordinary air or air with an adjusted oxygen partial pressure, inert gases such as nitrogen, argon, and helium can be used as the gas with which the tire is filled.

### EXAMPLES

Embodiments of the present invention are described in further detail below. However, the present invention is not limited to these embodiments.

### Synthesis of Nitrone Compound (Compound 1)

In a 2 L eggplant-shaped flask, methanol heated to 40° C. (900 mL) was placed, and then terephthalaldehydic acid represented by Formula (b-1) below (30.0 g) was added and dissolved. To this solution, a solution in which phenylhydroxylamine represented by Formula (a-1) below (21.8 g) was dissolved in methanol (100 mL) was added and stirred at room temperature for 19 hours. After the completion of stirring, a nitrone compound (carboxynitrone) (41.7 g) represented by Formula (c-1) below was obtained by recrystallization from methanol. The yield was 86%.

The carboxynitrone obtained thus is referred to as the compound 1. Also, the average major axis length of the compound 1 particles was determined using the digital microscope (KH-7700, available from Hirox Co., Ltd.) and found to be 120 μm.

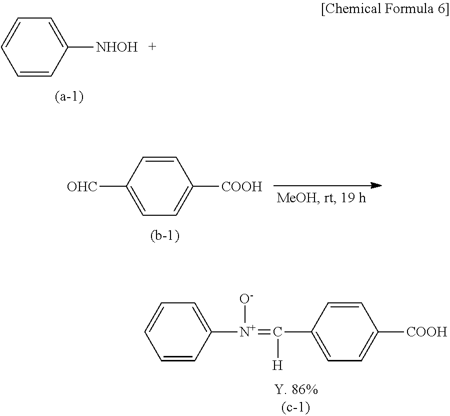

### Size Adjustment of Nitrone Compound

The compound 1 was pulverized using the method below to adjust the average major axis length of the particles.

### (1) Pulverization by Ball Mill

The compound 1 was pulverized using a planetary ball mill (PULVERISETTE 6, available from Fritsch, zirconia vessel), at a rotational speed of 500 rpm for 10 minutes.

The carboxynitrone after pulverization is referred to as the compound 2. Also, the average major axis length of the compound 2 particles was determined using the digital microscope (KH-7700, available from Hirox Co., Ltd.) and found to be 55 μm.

### (2) Pulverization by Jet Mill

The compound 1 was pulverized using a jet mill (JOM-mini, available from Seishin Enterprise Co., Ltd.) at an outlet air pressure of 0.4 MPa.

The carboxynitrone after pulverization is referred to as the compound 3. Also, the average major axis length of the compound 3 particles was determined using the digital microscope (KH-7700, available from Hirox Co., Ltd.) and found to be 15 μm.

### (3) Pulverization by Jet Mill

The compound 1 was pulverized in the same manner as in the case for the compound 3 except the outlet air pressure was 0.6 MPa.

The carboxynitrone after pulverization is referred to as the compound 4. Also, the average major axis length of the compound 4 particles was determined using the digital microscope (KH-7700, available from Hirox Co., Ltd.) and found to be 10 μm.

### (4) Pulverization by Pestle and Mortar

The compound 1 was pulverized using a pestle and mortar.

The carboxynitrone after pulverization is referred to as the compound 5. Also, the average major axis length of the compound 5 particles was determined using the digital microscope (KH-7700, available from Hirox Co., Ltd.) and found to be 5 μm.

### Preparation of Modified SBR

Unmodified emulsion-polymerized styrene-butadiene rubber (Nipol 1739, oil extended product containing 37.5 parts by mass of oil component per 100 parts by mass of the rubber component, available from ZEON CORPORATION) was charged in a Banbury mixer at a temperature of 120° C. and masticated for two minutes. Thereafter, the synthesized and adjusted carboxynitrone (compound 1 to 5) was blended at the proportion (part by mass) shown in Table 1 below, and the mixture was mixed under the modification conditions (temperature, duration) shown in Table 1 to prepare modified SBR 1 to 5.

The obtained modified SBR 1 to 5 were measured via NMR and the degree of modification of each was found. Specifically, the polymers before and after modification were measured for the peak area (derived from two protons adjacent to the carboxy group) at around 8.08 ppm via ¹H-NMR (CDCl₃, 400 MHz, TMS) using CDCl₃ as a solvent to find the degree of modification. Note that the samples used in the ¹H-NMR measurement of the modified polymer (modified SBR) were dissolved in toluene, purified by methanol precipitation 2 times, and then dried under reduced pressure. The results are shown in Table 1.

TABLE 1

| | | Modified SBR | | | | |
|---|---|---|---|---|---|---|
| | | 1 | 2 | 3 | 4 | 5 |
| SBR (unmodified) | | 100.00 | 100.00 | 100.00 | 100.00 | 100.00 |
| Carboxynitrone | Compound 1 (average | 1.00 | | | | |
| | length: 120 μm) | | | | | |
| | Compound 2 (average | | 1.00 | | | |
| | length: 55 μm) | | | | | |
| | Compound 3 (average | | | 1.00 | | |
| | length: 15 μm) | | | | | |
| | Compound 4 (average | | | | 1.00 | |
| | length: 10 μm) | | | | | |
| | Compound 5 (average | | | | | 1.00 |
| | length: 5 μm) | | | | | |

| | | | | | |
|---|---|---|---|---|---|
| Modification condition | 160° C. | 160° C. | 160° C. | 160° C. | 160° C. |
| | 5 minutes | 5 minutes | 5 minutes | 5 minutes | 5 minutes |
| Degree of modification (mol %) | 0.162 | 0.168 | 0.213 | 0.226 | 0.257 |
| Remarks | Comparative | Comparative | Example 1 | Example 2 | Example 3 |
| | Example 1 | Example 2 | | | |

### Standard Example 1, Comparative Example 1 to 2, and Examples 1 and 3

### Preparation of Rubber Composition

The components shown in Table 2 below were blended in the proportions (part by mass) shown in Table 2 below. Specifically, the components shown in Table 2 below except sulfur and the vulcanization accelerator were first mixed in a Banbury mixer with a temperature of 80° C. for 5 minutes. Thereafter, a roll was used to mix the sulfur and the vulcanization accelerator to obtain a rubber composition.

### Evaluation of Tensile Properties

The prepared rubber composition (unvulcanized) was vulcanized at 150° C. for 15 minutes to prepare a vulcanized rubber composition.

Thereafter, the prepared vulcanized rubber composition was cut out into a dumbbell shape (No. 3 dumbbell shape) having a thickness of 2 mm and used as a test piece.

For the obtained test piece, tensile strength (TB) (unit: MPa), and elongation at break (EB) (unit: %) were measured by performing a test at a tensile test speed of 500 mm/min at room temperature in accordance with JIS K 6251.

The results are shown in Table 2 below. Note that in Table 2 below, the measurement results shown as index values with the results of Standard Example being defined as 100. The composition can be evaluated as having superior tensile properties when the index value is larger.

### tan δ (60° C.)

A vulcanized rubber sheet was prepared by press-vulcanizing the prepared (unvulcanized) rubber compositions for 20 minutes at 160° C. in a mold (15 cm×15 cm×0.2 cm).

The vulcanized rubber sheet prepared as described above was measured for loss tangent at a temperature of 60° C., tan δ (60° C.) using a viscoelastic spectrometer (available from Toyo Seiki Seisaku-sho, Ltd.) under the following conditions: 10% initial distortion, ±2% amplitude, and 20 Hz frequency.

The results are shown in Table 2 below. Note that in Table 2 below, the measurement results shown as index values with the results of Standard Example being defined as 100. Smaller index values (i.e. smaller value of tan δ (60° C.)) indicate lower heat build-up (preferred result).

TABLE 2

| | | Comparative | | | | |
|---|---|---|---|---|---|---|
| | Reference | Examples | | Examples | | |
| | Example | 1 | 2 | 1 | 2 | 3 |
| Natural rubber | 25.0 | 25.0 | 25.0 | 25.0 | 25.0 | 25.0 |
| SBR 1 | 82.5 | 47.5 | 47.5 | 47.5 | 47.5 | 47.5 |
| Rubber composition | (60.0) | (34.5) | (34.5) | (34.5) | (34.5) | (34.5) |
| BR 1 | 15.0 | 15.0 | 15.0 | 15.0 | 15.0 | 15.0 |
| Modified SBR 1 | — | 35 | — | — | — | — |
| Rubber composition | | (25.5) | | | | |
| Modified SBR 2 | — | — | 35 | — | — | — |
| Rubber composition | | | (25.5) | | | |
| Modified SBR 3 | — | — | — | 35 | — | — |
| Rubber composition | | | | (25.5) | | |
| Modified SBR 4 | — | — | — | — | 35 | — |
| Rubber composition | | | | | (25.5) | |
| Modified SBR 5 | — | — | — | — | — | 35 |
| Rubber composition | | | | | | (25.5) |
| Silica | 30.0 | 30.0 | 30.0 | 30.0 | 30.0 | 30.0 |
| Carbon black | 30.0 | 30.0 | 30.0 | 30.0 | 30.0 | 30.0 |
| Zinc white | 3.0 | 3.0 | 3.0 | 3.0 | 3.0 | 3.0 |
| Stearic acid | 2.0 | 2.0 | 2.0 | 2.0 | 2.0 | 2.0 |
| Anti-aging agent | 2.0 | 2.0 | 2.0 | 2.0 | 2.0 | 2.0 |
| Silane coupling agent | 2.0 | 2.0 | 2.0 | 2.0 | 2.0 | 2.0 |
| Sulfur | 1.5 | 1.5 | 1.5 | 1.5 | 1.5 | 1.5 |
| Vulcanization accelerator 1 | 2.0 | 2.0 | 2.0 | 2.0 | 2.0 | 2.0 |
| Vulcanization accelerator 2 | 0.5 | 0.5 | 0.5 | 0.5 | 0.5 | 0.5 |
| TB (MPa) | 100 | 96 | 91 | 122 | 120 | 125 |
| EB (%) | 100 | 93 | 86 | 108 | 106 | 111 |
| tan δ (60° C.) | 100 | 84 | 84 | 76 | 73 | 70 |

The details of each component shown in Table 2 above are as follows.
Natural rubber: TSR20
SBR 1: emulsion-polymerized styrene-butadiene rubber; oil extended product containing 37.5 parts by mass of oil component per 100 parts by mass of rubber component; Nipol 1739, available from ZEON CORPORATION
BR 1: Nipol BR1220 (available from ZEON CORPORATION)
Modified SBR 1 to 5: modified butadiene rubber described in Table 1 above
Silica: ZEOSIL 165GR (available from Rhodia Silica Korea Co., Ltd.)
Carbon black: Show Black N339 (available from Cabot Japan K.K.)
Zinc oxide: Zinc Oxide III (available from Seido Chemical Industry Co., Ltd.)
Stearic acid: Stearic acid YR (available from NOF Corporation)
Anti-aging agent: SANTOFLEX 6PPD (available from Soltia Europe)
Silane coupling agent: Si69 (available from Evonik Degussa)
Sulfur: oil treatment sulfur (available from Karuizawa Refinery Ltd.)
Vulcanization accelerator 1: NOCCELER CZ-G (available from Ouchi Shinko Chemical Industrial Co., Ltd.)
Vulcanization accelerator 2: Soxinol D-G (available from Sumitomo Chemical Co., Ltd.)

Evident from Table 1 and Table 2, in the cases where the nitrone compound in particulate form having the average major axis length greater than 50 μm was used, the degree of modification was low and the heat build-up reduction property was insufficient (Comparative Example 1 and 2).

On the other hand, in the cases where the nitrone compound in particulate form having the average major axis length not greater than 50 μm was used, the degree of modification was sufficiently low and, surprisingly, the tensile properties have shown improvement (Example 1 to 3).

### REFERENCE SIGNS LIST

1 Bead portion
2 Sidewall portion
3 Tire tread portion
4 Carcass layer
5 Bead core
6 Bead filler
7 Belt layer
8 Rim cushion

1. A method of producing a modified polymer comprising:
modifying a conjugated diene polymer (A) with a nitrone compound (B) having a carboxy group,
wherein the nitrone compound (B) is in particulate form, having an average major axis length of not greater than 50 μm.

2. The method according to claim 1, wherein the nitrone compound (B) is represented by Formula (1): 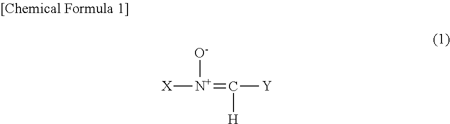
where X and Y each independently represent an aliphatic hydrocarbon group, an aromatic hydrocarbon group, or an aromatic heterocyclic group; and at least one of X and Y comprises a carboxy group as a substituent.

3. The method according to claim 1, wherein the nitrone compound (B) is represented by Formula (2): 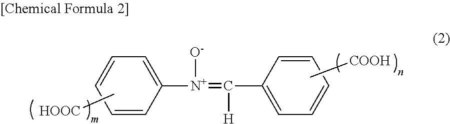
where, m and n each independently represent integers of 0 to 5, and a sum of m and n is 1 or greater.

4. The method according to claim 1, wherein the nitrone compound (B) is a compound selected from the group consisting of N-phenyl-α-(4-carboxyphenyl)nitrone, N-phenyl-α-(3-carboxyphenyl)nitrone, N-phenyl-α-(2-carboxyphenyl)nitrone, N-(4-carboxyphenyl)-α-phenylnitrone, N-(3-carboxyphenyl)-α-phenylnitrone, and N-(2-carboxyphenyl)-α-phenylnitrone.

5. The method according to claim 1, wherein an amount of the nitrone compound (B) reacted with the conjugated diene polymer (A) is from 0.1 to 10 parts by mass per 100 parts by mass of the conjugated diene polymer (A).

6. A modified polymer obtained by the method described in claim 1.

7. A rubber composition comprising the modified polymer described in claim 6.

8. A pneumatic tire using the rubber composition described in claim 7.

9. The method according to claim 2, wherein the nitrone compound (B) is represented by Formula (2): 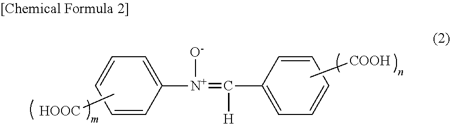
where, m and n each independently represent integers of 0 to 5, and a sum of m and n is 1 or greater.

10. The method according to claim 2, wherein the nitrone compound (B) is a compound selected from the group consisting of N-phenyl-α-(4-carboxyphenyl)nitrone, N-phenyl-α-(3-carboxyphenyl)nitrone, N-phenyl-α-(2-carboxyphenyl)nitrone, N-(4-carboxyphenyl)-α-phenylnitrone, N-(3-carboxyphenyl)-α-phenylnitrone, and N-(2-carboxyphenyl)-α-phenylnitrone.

11. The method according to claim 3, wherein the nitrone compound (B) is a compound selected from the group consisting of N-phenyl-α-(4-carboxyphenyl)nitrone, N-phenyl-α-(3-carboxyphenyl)nitrone, N-phenyl-α-(2-carboxyphenyl)nitrone, N-(4-carboxyphenyl)-α-phenylnitrone, N-(3-carboxyphenyl)-α-phenylnitrone, and N-(2-carboxyphenyl)-α-phenylnitrone.

12. The method according to claim 2, wherein an amount of the nitrone compound (B) reacted with the conjugated diene polymer (A) is from 0.1 to 10 parts by mass per 100 parts by mass of the conjugated diene polymer (A).

13. The method according to claim 3, wherein an amount of the nitrone compound (B) reacted with the conjugated diene polymer (A) is from 0.1 to 10 parts by mass per 100 parts by mass of the conjugated diene polymer (A).

14. The method according to claim 4, wherein an amount of the nitrone compound (B) reacted with the conjugated diene polymer (A) is from 0.1 to 10 parts by mass per 100 parts by mass of the conjugated diene polymer (A).

15. A modified polymer obtained by the method described in claim 2.

16. A modified polymer obtained by the method described in claim 3.

17. A modified polymer obtained by the method described in claim 4.

18. A modified polymer obtained by the method described in claim 5.
